(19) United States
(12) Patent Application Publication
(10) Pub. No.: US 2013/0342341 A1
(43) Pub. Date: Dec. 26, 2013

(54) TIRE MONITORING SYSTEM AND METHOD

(71) Applicants: Craig T. Simmerman, Howell, MI (US); Anthony D. Grutta, South Lyon, MI (US); David J. Trzcinski, Howell, MI (US); Richard W. Wiese, Highland, MI (US)

(72) Inventors: Craig T. Simmerman, Howell, MI (US); Anthony D. Grutta, South Lyon, MI (US); David J. Trzcinski, Howell, MI (US); Richard W. Wiese, Highland, MI (US)

(73) Assignee: GM GLOBAL TECHNOLOGY OPERATIONS LLC., Detroit, MI (US)

(21) Appl. No.: 13/532,064

(22) Filed: Jun. 25, 2012

(51) Int. Cl. G01J 5/02; G08B 21/18

(52) U.S. Cl. 340/449; 374/121

(57) ABSTRACT

A vehicle tire monitoring system including a tire and wheel assembly. The tire and wheel assembly may include a wheel having a rim portion including an inside surface; a tire including a tire carcass having an inner surface and an outer surface with a tire tread over a radially outer portion of the outer surface, and with the inner surface and the inside surface of the rim portion forming a cavity in which pressurized air is sealed; and a tire sensor assembly mounted on the inside surface of the rim portion in the cavity and including an infrared sensor and a wireless transmitter operatively engaging the infrared sensor, with the infrared sensor oriented to detect a temperature on the inner surface of the tire carcass at a location opposite to a portion of the tire tread.

### BACKGROUND OF INVENTION

The present invention relates generally to tire monitors and temperature sensors used with vehicle tires.

It may be desirable in tire pressure measurement systems to accurately measure the tire tread temperature. Some have measured the temperature of the air inside the tire to estimate the tire tread temperature. However, this is a slow changing measurement relative to the tire tread temperature and does not necessarily accurately reflect the tire tread temperature for various vehicle operating conditions. Others use a thermocouple and slip ring, but these types of arrangements may not be as durable as desired and may be more costly than is desired for a vehicle. Still others employ exterior mounted infrared sensors directed toward the tire tread, but these sensors can become dirty relatively quickly, which may cause them to stop working. Some have employed tire temperature modeling to estimate the tire tread temperature, but this may not be as accurate as desirable for all vehicle applications.

### SUMMARY OF INVENTION

An embodiment contemplates a vehicle tire monitoring system including a tire and wheel assembly. The tire and wheel assembly may include a wheel having a rim portion including an inside surface; a tire including a tire carcass having an inner surface and an outer surface with a tire tread over a radially outer portion of the outer surface, and with the inner surface and the inside surface of the rim portion forming a cavity in which pressurized air is sealed; and a tire sensor assembly mounted on the inside surface of the rim portion in the cavity and including an infrared sensor and a wireless transmitter operatively engaging the infrared sensor, with the infrared sensor oriented to detect a temperature on the inner surface of the tire carcass at a location opposite to a portion of the tire tread.

An embodiment contemplates a method of detecting a tire tread temperature of a tire and wheel assembly of a vehicle, the method comprising the steps of: locating an infrared sensor on an inside surface of a rim of a wheel within a pressurized air cavity formed by the rim and an inner surface of a tire carcass, with the infrared sensor oriented to detect a temperature of the inner surface of the tire carcass at a location opposite from a portion of a tire tread on an outer surface of the tire carcass; detecting a temperature on the inner surface of the tire carcass with the infrared sensor; and wirelessly transmitting the detected temperature to a tire sensor receiver in the vehicle.

An advantage of an embodiment is that measuring the tire carcass temperature has a fast response time for detecting changes in tire tread temperature. Also, the mounting location of the sensor measuring the temperature allows the sensor to remain clean (free of dirt or other debris), thus maintaining reliable and accurate sensor data reliable and accurate over a long time period. Further, the temperature is taken without any tire contact yet accurately detects tire tread temperature. By providing the tire temperature data, the vehicle control systems can account for differences in tire traction that may occur at different tire temperatures. In addition, the advantages of the invention are provided while adding little weight.

### BRIEF DESCRIPTION OF DRAWINGS

FIG. 1 is a schematic view of a vehicle having a tire monitoring system.

FIG. 2 is a schematic view of a cross section of a portion of a wheel and tire assembly having a tire sensor assembly.

FIG. 3 is a flow chart illustrating a method of operating the tire monitoring system.

### DETAILED DESCRIPTION

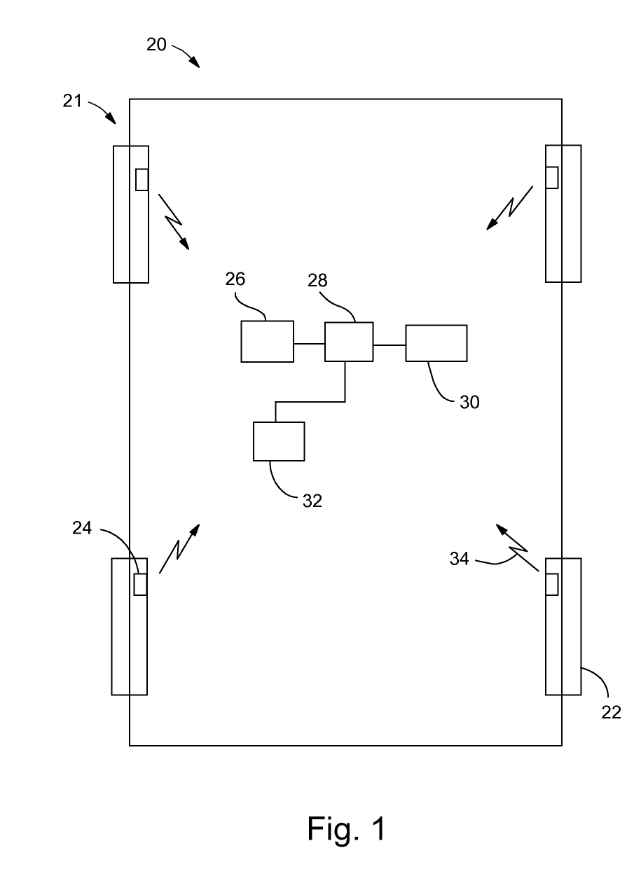

Referring to FIG. 1, a vehicle, indicated generally at 20, is shown. The vehicle 20 has a tire monitoring system 21 and includes tire and wheel assemblies 22 that each have a tire sensor assembly 24 mounted inside. The tire sensor assemblies 24 each transmit signals 34 to a tire sensor receiver 26. The tire sensor receiver 26 communicates with a controller 28. The controller 28 may be any one or more of various controllers employed with vehicles and may be made up of various combinations of hardware and software as is known to those skilled in the art. For example, the controller 28 may be a chassis controller—although it may include one or more different vehicle controllers. The controller 28 may communicate with one or more vehicle systems 30. The vehicle systems 30 may include, for example, anti-lock brake systems, traction control systems, stability control systems, or other types of vehicle systems. These systems are known to those skilled in the art and so will not be discussed in further detail herein. The controller 28 may also communicate with a driver indicator 32, such as a light or sound producing assembly that is visible/audible to the vehicle driver.

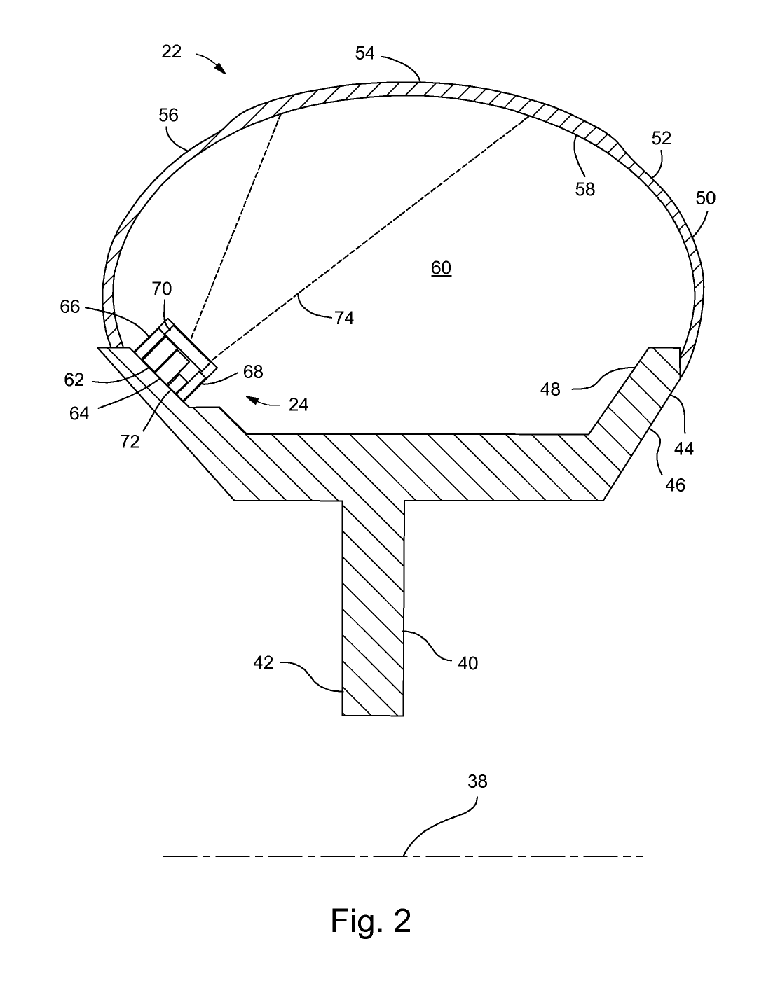

Referring to FIG. 2, a portion of one of the tire and wheel assemblies 22 is shown schematically in more detail. The schematic cross section shows a portion of the assembly 22 above a wheel centerline 38. A wheel 40 includes a radially extending center portion 42 connected to a rim portion 44. The rim 44 has an outer surface 46 that is exposed to the elements and an inside surface 48 that is sealed from the elements by a tire 50. The tire 50 has a tire carcass 52 with radially outward extending tire treads 54 on a portion of an outer surface 56. The inner surface 58 of the tire carcass 52, along with the inside surface 48 of the rim 44 form a cavity 60 within which pressurized air is maintained.

Mounted to the inside surface 48 of the rim 44, within the cavity 60, is the tire sensor assembly 24. The tire sensor assembly 24 may include a battery 62, a TPM controller 64, a transmitter 66, a pressure sensor 68 and an infrared sensor 70. The battery 62 provides power to the assembly 24. The TPM controller 64 receives information from the sensors 68, 70 and determines when the information is wirelessly transmitted by the transmitter 66 to the tire sensor receiver (FIG. 1). The pressure sensor 68 senses the pressure in the cavity 60. The infrared sensor 70 is mounted facing the inner surface 58 of the tire carcass 52, for reading the temperature on this inner surface 58. The portion of the inner surface 58 where the infrared sensor is aimed is opposite a portion of the tire tread 54. The term opposite, as used herein, means that the particular portion of the inner surface 58 is adjacent to and directly radially inward of the corresponding portion of the tire tread 54.

The dashed lines 74 in FIG. 2 indicate the area where the infrared sensor 70 takes the temperature reading on the inner surface 58 based on the orientation of the sensor 70. The mounting location of the infrared sensor 70, within the cavity 60, assures that the sensor 70 is not exposed to dirt and other debris that may interfere with its proper operation, while detecting the tire tread temperature at the desired location.

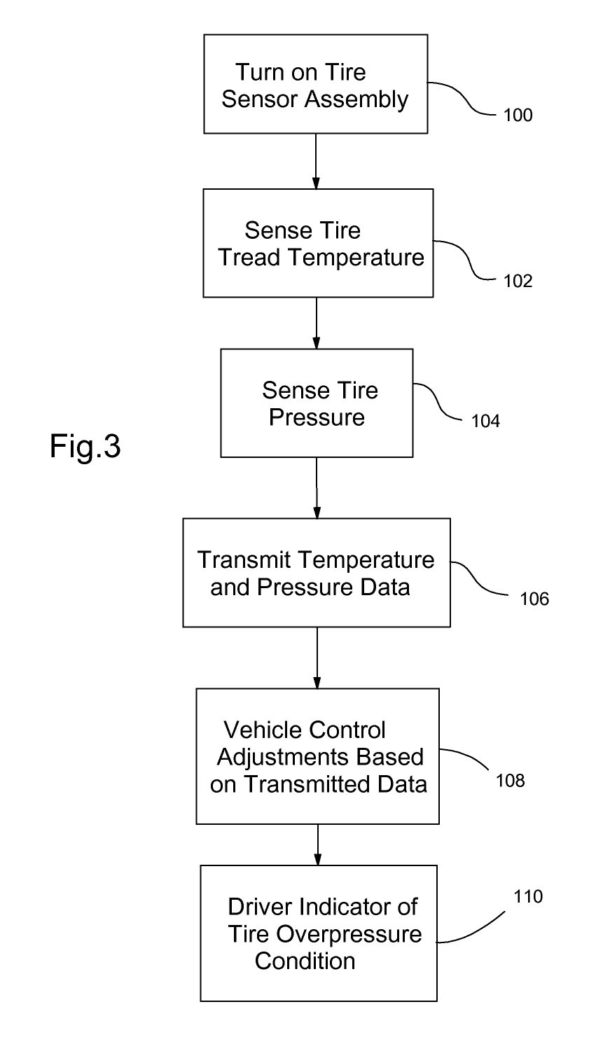

The operation of the vehicle 20 and tire monitoring system 21 will now be described with reference to FIGS. 1-3. The tire sensor assembly 24 may be continuously on or may be activated by any means desired—for example, a centrifugal switch 72 may be employed to turn on the assembly 24, if so desired. A centrifugal switch 72 may remain off until the tire begins to rotate (or reaches a predetermined rotational speed) causing the switch to actuate, turning on the tire sensor assembly 24, block 100. As the vehicle 20 is traveling, the infrared sensor 70 and pressure sensor 68 sense tire tread temperature, block 102, and tire pressure, block 104, respectively. The tire tread temperature is sensed on the inner surface 58 of the tire carcass 52, opposite to a portion of the tire treads 54.

Periodically, the transmitter 66 will wirelessly transmit the pressure and temperature data, which is received by the tire sensor receiver 26, block 106. The desirable time interval for data transmission is known to those skilled in the art and will not be discussed further herein.

The tire sensor receiver 26 communicates the tire data to the controller 28, which may employ this data to make adjustments to the vehicle systems 30 where the tire tread temperature may be relevant to vehicle operation, block 108. The tire tread temperature may be relevant, for example, where compensation for cold/hot tire performance, detection of excessive tire slip, monitoring/detecting tire wear, and/or tire failure are significant vehicle performance parameters. The data can be used, for example, to adjust an anti-lock brake system, traction control system, stability control system, or other vehicle systems. In addition, since the temperature of the tire carcass is being measured, changes in tire tread temperature can be detected and transmitted relatively quickly to the vehicle systems, allowing for real time adjustments to be made.

Also, the controller 28 may employ the data from the tire sensor assembly 24 to activate the driver indicator 32 to warn a vehicle driver of a possible tire over-temperature failure condition, block 110. The driver indicator 32 may be a light on the instrument panel and/or a sound transmitted into the passenger compartment.

While certain embodiments of the present invention have been described in detail, those familiar with the art to which this invention relates will recognize various alternative designs and embodiments for practicing the invention as defined by the following claims.

What is claimed is:

1. A vehicle tire monitoring system comprising:
a tire and wheel assembly including:
a wheel having a rim portion, the rim portion including an inside surface;
a tire including a tire carcass having an inner surface and an outer surface with a tire tread over a radially outer portion of the outer surface, the inner surface and the inside surface of the rim portion forming a cavity in which pressurized air is sealed; and
a tire sensor assembly mounted on the inside surface of the rim portion in the cavity, the tire sensor assembly including an infrared sensor and a wireless transmitter operatively engaging the infrared sensor, the infrared sensor oriented to detect a temperature on the inner surface of the tire carcass at a location opposite to a portion of the tire tread.

2. The vehicle tire monitoring system of claim 1 wherein the tire sensor assembly includes a pressure sensor configured to measure air pressure in the cavity.

3. The vehicle tire monitoring system of claim 1 including a tire sensor receiver configured to wirelessly receive a tire tread temperature signal from the tire sensor assembly.

4. The vehicle tire monitoring system of claim 3 including a controller in communication with the tire sensor receiver.

5. The vehicle tire monitoring system of claim 4 including a vehicle system in communication with the controller, the vehicle system configured to adjust operation based on the tire tread temperature signal.

6. The vehicle tire monitoring system of claim 4 including a driver indicator in communication with the controller and configured to be activated based at least in part on the tire tread temperature signal.

7. The vehicle tire monitoring system of claim 1 wherein the tire sensor assembly includes a wireless transmitter configured to wirelessly transmit the temperature detected by the infrared sensor.

8. The vehicle tire monitoring system of claim 1 wherein the tire sensor assembly includes a centrifugal switch configured to activate the tire sensor assembly.

9. A method of detecting a tire tread temperature of a tire and wheel assembly of a vehicle, the method comprising the steps of:
(a) locating an infrared sensor on an inside surface of a rim of a wheel within a pressurized air cavity formed by the rim and an inner surface of a tire carcass, with the infrared sensor oriented to detect a temperature of the inner surface of the tire carcass at a location opposite from a portion of a tire tread on an outer surface of the tire carcass;
(b) detecting a temperature on the inner surface of the tire carcass with the infrared sensor; and
(c) wirelessly transmitting the detected temperature to a tire sensor receiver in the vehicle.

10. The method of claim 9 further comprising:
(d) adjusting a vehicle system based on the detected temperature.

11. The method of claim 9 further comprising:
(d) detecting an air pressure in the cavity with a pressure sensor;
(e) wirelessly transmitting the detected air pressure to the tire sensor receiver.

12. The method of claim 9 wherein step (b) is further defined by activating the infrared sensor when the tire and wheel assembly is rotating.

13. The method of claim 9 further comprising:
(d) activating a driver indicator to alert a driver of the vehicle based at least in part on the detected temperature.
